(19) United States
(12) Patent Application Publication
(10) Pub. No.: US 2019/0218080 A1
(43) Pub. Date: Jul. 18, 2019

(54) ELECTRIC LOAD LIFTING APPARATUS

(71) Applicant: PUC Perfect Union Co., Ltd., New Taipei (TW)

(72) Inventor: Ching Chan, TW (TW)

(21) Appl. No.: 15/871,232

(22) Filed: Jan. 15, 2018

(51) Int. Cl. B66F 7/06; B66F 7/28

(52) U.S. Cl. CPC B66F 7/0666; B66F 7/0608; B66F 7/28

(57) ABSTRACT

An electric load lifting apparatus includes a rectangular lower frame, a rectangular upper frame, two lower pairs of scissors type levers, a transverse rod, two upper pairs of scissors type levers, a rear transverse member, a front transverse member having a handle, a support secured to the front transverse member, and a servo motor secured to the support and including a threaded shaft rotatably disposed through an internally threaded sleeve of the rear transverse member. The servo motor is activated to rotate the threaded shaft in a first direction to lower the internally threaded sleeve, thereby collapsing the upper frame or in a second direction opposing the first direction to lift the internally threaded sleeve, thereby extending the upper frame upward.

### BACKGROUND OF THE INVENTION

### 1. Field of the Invention

The invention relates to lifting apparatuses and more particularly to an electric lifting apparatus for loading a vehicle (e.g., mobility scooter).

### 2. Description of Related Art

A conventional scissors type of high lift truck mechanism includes pivotally connected levers and a hydraulic cylinder mounted below the chassis.

There is another conventional type of scissors type of elevating device in which three sets of hydraulic power devices are employed, one pushes vertically, directly on the scissors, the second is longitudinally disposed in the chassis frame and the third is similarly disposed in the elevator platform.

There is still another conventional high lift trailer employing scissors type of levers, pivotally connected intermediate their lengths.

While the device enjoys its success in the market, continuing improvements in the exploitation of load lifting apparatus are constantly being sought.

### SUMMARY OF THE INVENTION

It is therefore one object of the invention to provide an electric load lifting apparatus comprising a rectangular lower frame including two transverse members interconnecting two sides thereof respectively, two grooves each on an inner surface of a rear portion of either side, and a power socket on one transverse member; a rectangular upper frame including two transverse elements interconnecting two sides thereof respectively, a top platform, two troughs each on an inner surface of a rear portion of either side of the upper frame, a first set of two slots formed on a first portion of a front one of the transverse elements, a second set of two slots formed on a second portion of the front one of the transverse elements, a third set of two slots formed on a first portion of a rear one of the transverse elements, a fourth set of two slots formed on a second portion of the rear one of the transverse elements, two lower pairs of scissors type levers wherein a first lever of either lower pair of scissors type levers 3 is pivoted about a second lever thereof, a lower end of the first lever of either lower pair of scissors type levers is pivoted to an inner surface of either side of the lower frame, and a lower end of the second lever of either lower pair of scissors type levers is slidably disposed in the groove; a transverse rod having two ends pivotably secured to the lower end of the second lever of one lower pair of scissors type levers and the lower end of the second lever of the other lower pair of scissors type levers respectively; two upper pairs of scissors type levers wherein a first lever of either upper pair of scissors type levers is pivoted about a second lever thereof, and an upper end of the first lever of either upper pair of scissors type levers is pivoted to an inner surface of either side of the upper frame, an upper end of the second lever of either upper pair of scissors type levers is slidably disposed in the trough, a lower end of the first lever of either upper pair of scissors type levers is pivoted to an upper end of the first lever of one lower pair of scissors type levers at the same side of the electric load lifting apparatus, and a lower end of the second lever of either upper pair of scissors type levers is pivoted to an upper end of the second lever of one lower pair of scissors type levers at the same side of the electric load lifting apparatus; a rear transverse member having two ends pivotably secured to the lower end of the second lever of one upper pair of scissors type levers and the lower end of the second lever of the other upper pair of scissors type levers respectively, the rear transverse member including an internally threaded sleeve through itself; a front transverse member having two ends pivotably secured to the upper end of the second lever of one lower pair of scissors type levers and the upper end of the second lever of the other lower pair of scissors type levers respectively; a handle disposed on an intermediate portion of the front transverse member; a support secured to the front transverse member; and a servo motor secured to the support and including a threaded shaft rotatably disposed through the internally threaded sleeve; wherein the servo motor is activated by having one end of a power cord connected to the power socket and the other end thereof connected to an electrical outlet so that the threaded shaft rotates in a first direction to lower the internally threaded sleeve, thereby collapsing the upper frame or in a second direction opposing the first direction to lift the internally threaded sleeve, thereby extending the upper frame upward.

The above and other objects, features and advantages of the invention will become apparent from the following detailed description taken with the accompanying drawings.

### BRIEF DESCRIPTION OF THE DRAWINGS

FIG. 1 is a perspective view of an electric load lifting apparatus according to the invention;

FIG. 2 is another perspective view of FIG. 1;

FIG. 3 is a side elevation of FIG. 1 with a curtain mounted on one side of the load lifting apparatus;

FIG. 4 is a perspective view of the load lifting apparatus with curtains mounted on four sides thereof;

FIG. 5 is a perspective view of the load lifting apparatus in a collapsed state and a power cord to be connected to the load lifting apparatus;

FIG. 6 is a side elevation of the load lifting apparatus in the collapsed state;

FIG. 7 is a perspective view of a folding ramp in a folded state;

FIG. 8 is a perspective view of the folding ramp in an unfolded state;

FIG. 9 is a perspective view of the collapsed apparatus and two folding ramps unfolded to be ready for loading a mobility scooter on the apparatus; and

FIG. 10 is a side elevation of the collapsed apparatus with the mobility scooter loaded thereon.

### DETAILED DESCRIPTION OF THE INVENTION

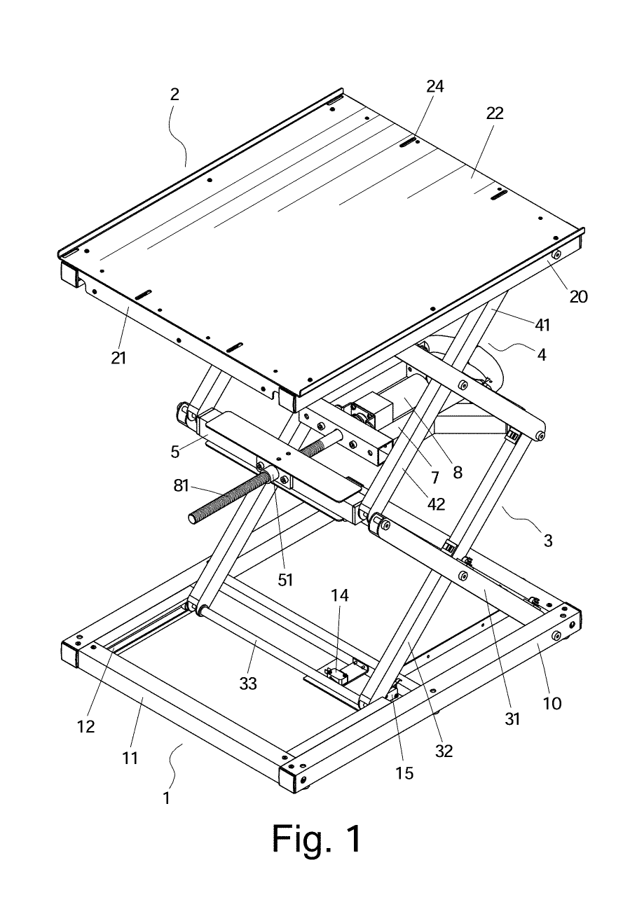

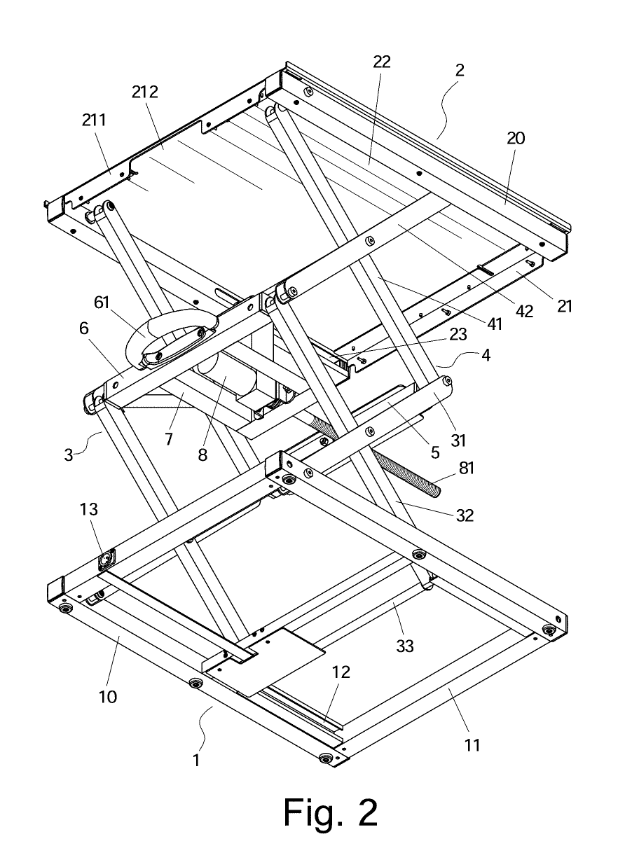

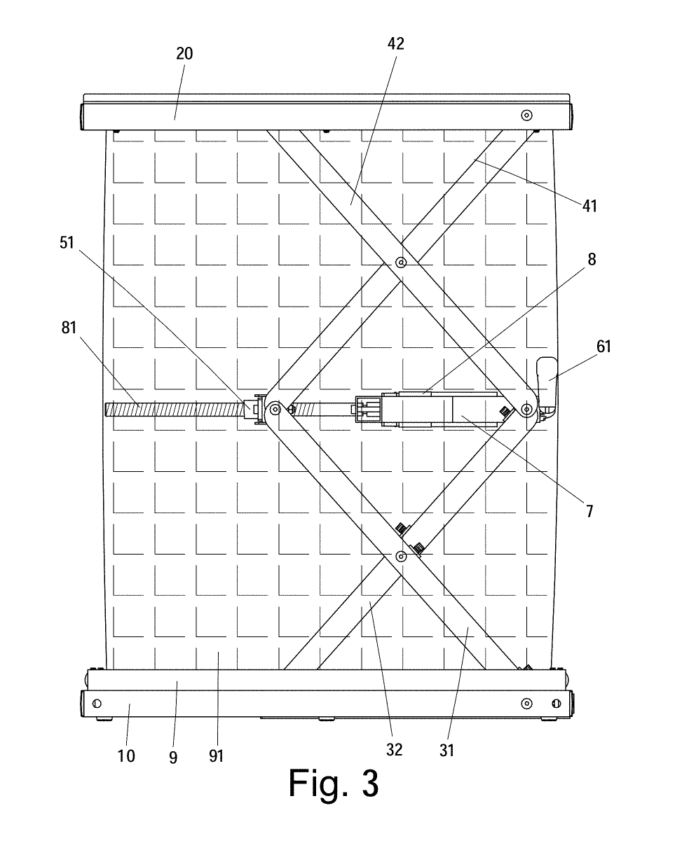

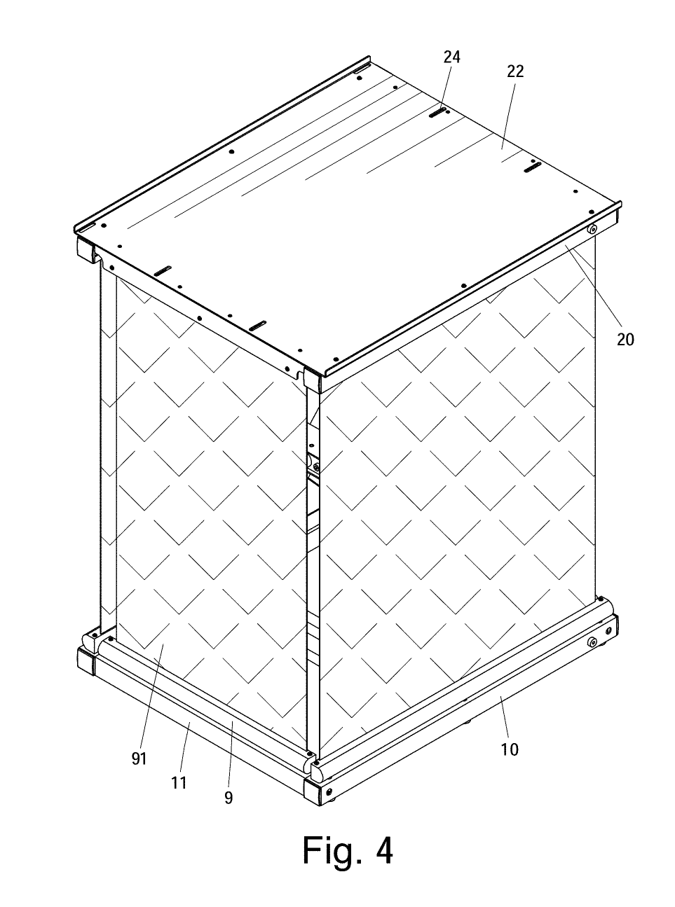

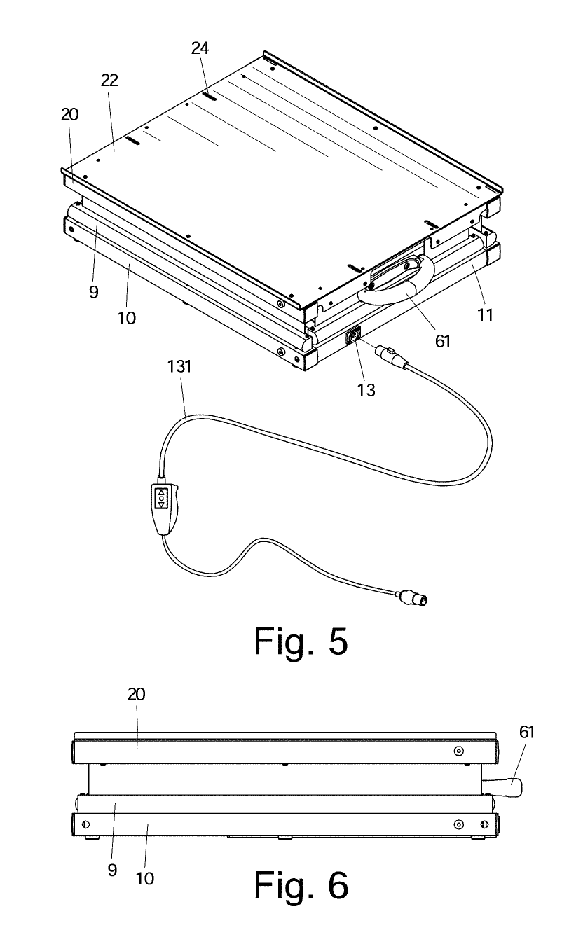

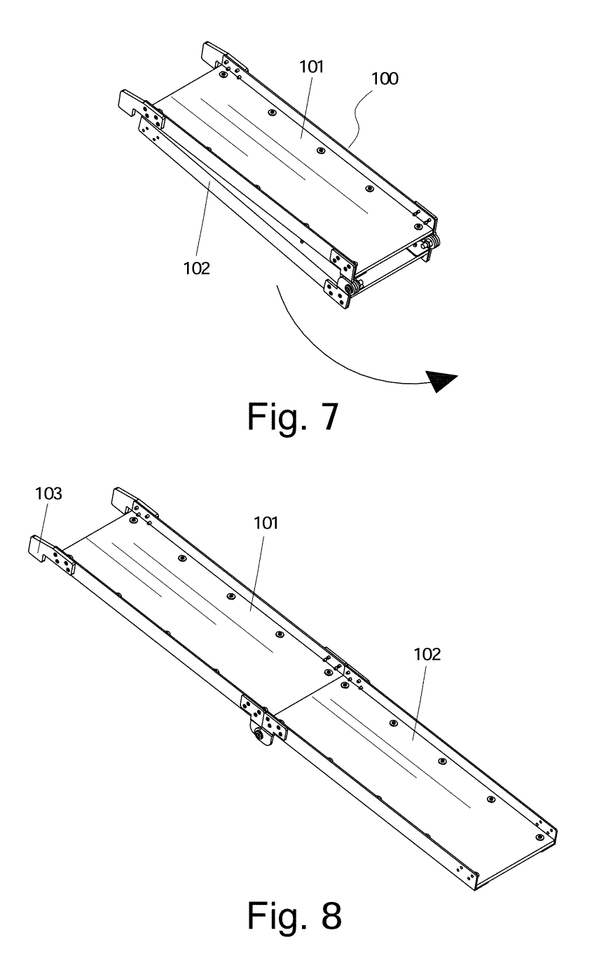

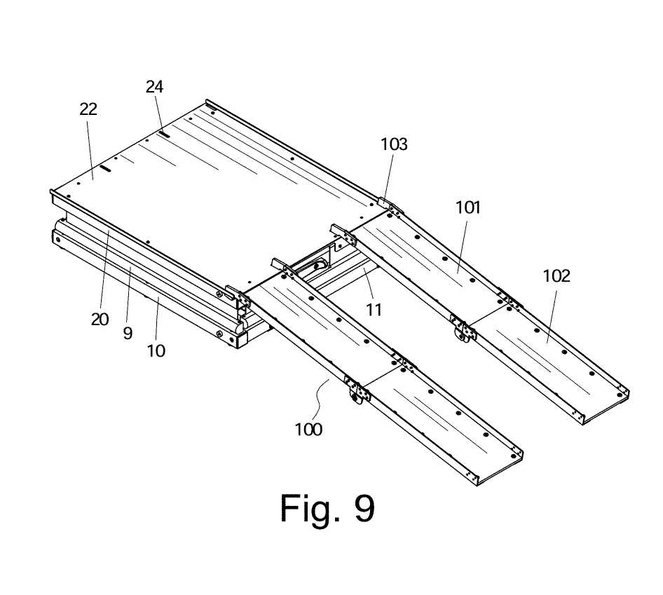

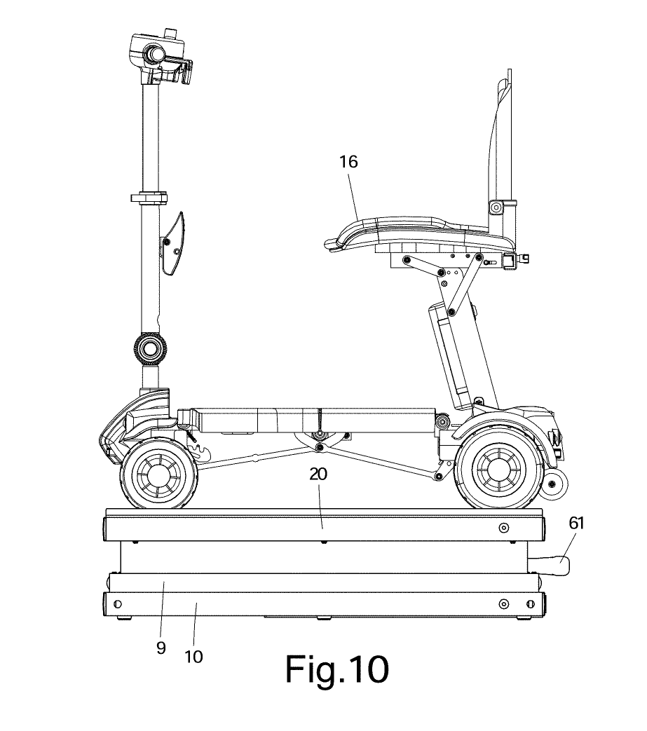

Referring to FIGS. 1 to 10, an electric load lifting apparatus in accordance with the invention comprises the following components as discussed in detail below.

Two folding ramps 100 each include a rectangular first section 101, a rectangular second section 102 pivotably secured to the first section 101, and two hooks 103 on two rear corners of the first section 101 respectively.

A lower frame 1 is made of aluminum alloy or the like and is a parallelogram (e.g., rectangle). The lower frame 1 includes two transverse members 11 interconnect two sides 10 thereof respectively, two grooves 12 each on an inner surface of a rear portion of either side 10 of the lower frame 1, and a power socket 13 on an outer surface of a front one of the transverse members 11. The length of the groove 12 is not greater than half of the length of either side 10 of the lower frame 1.

An upper frame 2 is made of aluminum alloy or the like and is a parallelogram (e.g., rectangle). The upper frame 2 includes two transverse elements 21 interconnect two sides 20 thereof respectively in which the front one of the transverse elements 21 is provided with two spaced rectangular elements 211 with a rectangular cut 212 disposed therebetween, a rectangular platform 22 on a top, two troughs 23 each on an inner surface of a rear portion of either side 20 of the upper frame 2, and eight slots 24 in which four slots 24 are grouped as a first set formed on the front one of the transverse elements 21 and the remaining four slots 24 are grouped as a second set formed on the rear one of the transverse elements 21. Further, the four slots 24 of the same set are further grouped as two sub-sets of two slots 24. The length of the trough 23 is not greater than half of the length of either side 20 of the upper frame 2.

Two lower pairs of scissors type levers 3 are provided in which a first lever 31 of either lower pair of scissors type levers 3 is pivoted by an intermediate pivot (not numbered) to a second lever 32 thereof, a lower end of the first lever 31 of either lower pair of scissors type levers 3 is pivoted to an inner surface of either side 10 of the lower frame 1 adjacent to one corner of the lower frame 1, a lower end of the second lever 32 of either lower pair of scissors type levers 3 is formed with a roller (not shown) slidably disposed in the groove 12, and a transverse rod 33 has two ends pivotably secured to the lower end of the second lever 32 of one lower pair of scissors type levers 3 and the lower end of the second lever 32 of the other lower pair of scissors type levers 3 respectively.

Two upper pairs of scissors type levers 4 are provided in which a first lever 41 of either upper pair of scissors type levers 4 is pivoted by an intermediate pivot (not numbered) to a second lever 42 thereof, an upper end of the first lever 41 of either upper pair of scissors type levers 4 is pivoted to an inner surface of either side 20 of the upper frame 2 adjacent to one corner of the upper frame 2, an upper end of the second lever 42 of either upper pair of scissors type levers 4 is formed with a roller (not shown) slidably disposed in the trough 23, a lower end of the first lever 41 of either upper pair of scissors type levers 4 is pivoted to an upper end of the first lever 31 of one lower pair of scissors type levers 3 at the same side of the electric load lifting apparatus, and a lower end of the second lever 42 of either upper pair of scissors type levers 4 is pivoted to an upper end of the second lever 32 of one lower pair of scissors type levers 3 at the same side of the electric load lifting apparatus.

A rear transverse member 5 has two ends pivotably secured to the lower end of the second lever 42 of one upper pair of scissors type levers 4 and the lower end of the second lever 42 of the other upper pair of scissors type levers 4 respectively.

A front transverse member 6 has two ends pivotably secured to the upper end of the second lever 32 of one lower pair of scissors type levers 3 and the upper end of the second lever 32 of the other lower pair of scissors type levers 3 respectively. A curved handle 61 is provided on an intermediate portion of the front transverse member 6 and may be disposed below the cut 212 in the collapsed position of the electric load lifting apparatus.

A support 7 is secured to the front transverse member 6. A servo motor 8 is secured to the support 7 and a threaded shaft 81 rotatably disposed through an internally threaded sleeve 51 through a center of the rear transverse member 5. The servo motor 8 can be activated by having one end of a power cord 131 connected to the power socket 13 and the other end thereof connected to an electrical outlet which is provided in one of a mobility scooter, a truck, an automobile, and a portable power supply. Further, the threaded shaft 81 rotates either clockwise to lower the internally threaded sleeve 51 (i.e., the rear transverse member 5), thereby collapsing the upper frame 2 or counterclockwise to lift the internally threaded sleeve 51 (i.e., the rear transverse member 5), thereby extending the upper frame 2 upward.

Two sides, a front portion and a rear portion of the electric load lifting apparatus are provided with a curtain 91 in which an upper end of the curtain 91 secured to either side 20 (or either transverse element 21) of the upper frame 2 and a lower end thereof is formed with a rod 9 releasably secured to either side 10 (or either transverse member 11) of the lower frame 1. The curtain 91 may pull out of the rod 9 in response to an upward movement of the upper frame 2 or wind around the rod 91 in response to a downward movement of the upper frame 2.

A first limit switch 14 and a second limit switch 15 are provided on a bottom of the lower frame 1. In a lifting operation by first activating the servo motor 8, the first limit switch 14 may be activated to shut off the servo motor 8 by contacting the transverse rod 33 when the upper frame 2 has reached the fully raised position. Likewise, in a lowering operation by first activating the servo motor 8, the second limit switch 15 may be activated to shut off the servo motor 8 by contacting the second lever 32 of one lower pair of scissors type levers 3 when the upper frame 2 has reached the fully lowered position.

For loading a vehicle (e.g., mobility scooter) 16 on the upper frame 2, an employee must fully lower the upper frame 2 and thereafter the employee may insert the hooks 103 of one fully unfolded folding ramp 10 into the slots 24 of one sub-set on the front end of the upper frame 2 and the hooks 103 of the other fully unfolded folding ramp 10 into the slots 24 of the other sub-set on the front end of the upper frame 2 respectively. Thereafter, the employee may push (or drive) the mobility scooter 16 upward along the folding ramps 10 to the upper frame 2.

While the invention has been described in terms of preferred embodiments, those skilled in the art will recognize that the invention can be practiced with modifications within the spirit and scope of the appended claims.

What is claimed is:

1. An electric load lifting apparatus, comprising:
a rectangular lower frame including two transverse members interconnecting two sides thereof respectively, two grooves each on an inner surface of a rear portion of either side, and a power socket on one transverse member;
a rectangular upper frame including two transverse elements interconnecting two sides thereof respectively, a top platform, two troughs each on an inner surface of a rear portion of either side of the upper frame, a first set of two slots formed on a first portion of a front one of the transverse elements, a second set of two slots formed on a second portion of the front one of the transverse elements, a third set of two slots formed on a first portion of a rear one of the transverse elements, a fourth set of two slots formed on a second portion of the rear one of the transverse elements;
two lower pairs of scissors type levers wherein a first lever of either lower pair of scissors type levers 3 is pivoted about a second lever thereof, a lower end of the first lever of either lower pair of scissors type levers is pivoted to an inner surface of either side of the lower frame, and a lower end of the second lever of either lower pair of scissors type levers is slidably disposed in the groove;
a transverse rod having two ends pivotably secured to the lower end of the second lever of one lower pair of scissors type levers and the lower end of the second lever of the other lower pair of scissors type levers respectively;
two upper pairs of scissors type levers wherein a first lever of either upper pair of scissors type levers is pivoted about a second lever thereof, and an upper end of the first lever of either upper pair of scissors type levers is pivoted to an inner surface of either side of the upper frame, an upper end of the second lever of either upper pair of scissors type levers is slidably disposed in the trough, a lower end of the first lever of either upper pair of scissors type levers is pivoted to an upper end of the first lever of one lower pair of scissors type levers at the same side of the electric load lifting apparatus, and a lower end of the second lever of either upper pair of scissors type levers is pivoted to an upper end of the second lever of one lower pair of scissors type levers at the same side of the electric load lifting apparatus;
a rear transverse member having two ends pivotably secured to the lower end of the second lever of one upper pair of scissors type levers and the lower end of the second lever of the other upper pair of scissors type levers respectively, the rear transverse member including an internally threaded sleeve through itself;
a front transverse member having two ends pivotably secured to the upper end of the second lever of one lower pair of scissors type levers and the upper end of the second lever of the other lower pair of scissors type levers respectively;
a handle disposed on an intermediate portion of the front transverse member;
a support secured to the front transverse member; and
a servo motor secured to the support and including a threaded shaft rotatably disposed through the internally threaded sleeve;
wherein the servo motor is activated by having one end of a power cord connected to the power socket and the other end thereof connected to an electrical outlet so that the threaded shaft rotates in a first direction to lower the internally threaded sleeve, thereby collapsing the upper frame or in a second direction opposing the first direction to lift the internally threaded sleeve, thereby extending the upper frame upward.

2. The electric load lifting apparatus of claim 1, further comprising a first limit switch and a second limit switch both provided on a bottom of the lower frame, wherein in a lifting operation by first activating the servo motor, the first limit switch is activated to shut off the servo motor by contacting the transverse rod when the upper frame has reached the fully raised position, and wherein in a lowering operation by first activating the servo motor, the second limit switch is activated to shut off the servo motor by contacting the second lever of one lower pair of scissors type levers when the upper frame has reached the fully lowered position.

3. The electric load lifting apparatus of claim 1, wherein the servo motor is powered by a mobility scooter, a truck, an automobile, or a portable power supply.

4. The electric load lifting apparatus of claim 1, wherein a front one of the transverse members is provided with two spaced rectangular elements with a cut disposed therebetween, and wherein the handle is configured to dispose below the cut in the collapsed position of the electric load lifting apparatus.

5. The electric load lifting apparatus of claim 1, further comprising four curtains wherein two sides, a front portion and a rear portion of the electric load lifting apparatus are provided with the curtains respectively, wherein an upper end of each curtain is secured to either side or either transverse member of the upper frame and a lower end thereof is formed with a rod releasably secured to either side or either transverse member of the lower frame, and wherein each curtain is configured to pull out of the rod in response to an upward movement of the upper frame or wind around the rod in response to a downward movement of the upper frame.

6. The electric load lifting apparatus of claim 1, further comprising two folding ramps each including a rectangular first section, a rectangular second section pivotably secured to the first section, and two hooks on two rear corners of the first section respectively, and wherein either folding ramp is configured to unfold to have its hooks inserted into (i) the first set of the slots or the second set of the slots, or (ii) the third set of the slots or the fourth set of the slots.
